(19) United States
(12) Patent Application Publication
(10) Pub. No.: US 2016/0253357 A1
(43) Pub. Date: Sep. 1, 2016

(54) INFORMATION TERMINAL, IMAGE SERVER, IMAGE SEARCH SYSTEM, AND IMAGE SEARCH METHOD

(71) Applicant: FUJIFILM Corporation, Tokyo (JP)

(72) Inventor: Hiroyuki FURUYA, Tokyo (JP)

(73) Assignee: FUJIFILM Corporation, Tokyo (JP)

(21) Appl. No.: 15/148,783

(22) Filed: May 6, 2016

Related U.S. Application Data
(63) Continuation of application No. PCT/JP2014/083939, filed on Dec. 22, 2014.

(30) Foreign Application Priority Data
Dec. 26, 2013 (JP) 2013-268766

(51) Int. Cl. G06F 17/30; G06K 7/10; G06K 19/06

(52) U.S. Cl. CPC G06F 17/30268; G06F 17/3028; G06K 19/06028; G06K 7/10386

(57) ABSTRACT

In an information terminal of the present invention, a relevant information acquisition unit acquires relevant information of a predetermined image from an information tag embedded in the predetermined image or the periphery of the predetermined image, a search condition generation unit generates search conditions to be used for image search in an image server based on the acquired relevant information, a display unit displays the predetermined image and displays the search conditions to be superimposed on the displayed predetermined image, a search condition transmission unit transmits the search conditions selected from the displayed search conditions to the image server, and a relevant image data reception unit receives at least one of relevant image data and information on the relevant image that are relevant to the predetermined image searched for based on the search conditions from the image server.

### CROSS REFERENCE TO RELATED APPLICATIONS

This application is a continuation application of International Application No. PCT/JP2014/083939 filed on Dec. 22, 2014, which claims priority under 35 U.S.C. 119(a) to Application No. 2013-268766 filed in Japan on Dec. 26, 2013, all of which are hereby expressly incorporated by reference into the present application.

### BACKGROUND OF THE INVENTION

1. Field of the Invention

The present invention relates to an information terminal, an image server, an image search system, and an image search method used for, for example, a printing service for printing a predetermined image according to an order of a user.

2. Description of the Related Art

A printing service for printing a predetermined image such as a photobook, a collage, and a postcard has been conventionally used. In recent years, an image search system and an image search method for searching for an image to be printed from a large amount of image data stored in an image server or the like have been used. Further, in the image search system and the image search method, an information terminal and the image server are used.

JP4337139B discloses a printing service system that accesses image data on a server by extracting an image to be printed from a moving image or a plurality of still images, recording the image and information on access to the image on a printing medium, and reading the recorded access information.

Further, JP4104055B discloses an image data storage system capable of performing efficient image searching due to storing attribute information of image data together with the image data.

### SUMMARY OF THE INVENTION

In the printing service system of JP4337139B, the image data on the server corresponding to a print image can be accessed by reading the recorded access information, but image data other than the print image cannot be accessed.

Further, in the image data storage system of JP4104055B, the attribute information is stored together with the image data. It is necessary for a user to input the attribute information in order to search for the image data using the attribute information as a keyword, which takes time and effort.

An object of the present invention is to provide an image search system and an image search method capable of searching for and referring to, for example, a plurality of items of image data having high relevance to a predetermined print image or a predetermined display image (hereinafter, predetermined image) from the image through a simple operation. Further, another object thereof is to provide an information terminal and an image server that are used for the image search system and the image search method.

In order to solve the above problems, the present invention provides an information terminal that is connected to an image server and performs image search for a plurality of items of image data stored in the image server, the information terminal comprising: a relevant information acquisition unit that acquires relevant information of a predetermined image based on an information tag of captured image data including the predetermined image and the information tag corresponding to the predetermined image; a search condition generation unit that generates search conditions to be used for the image search in the image server based on the acquired relevant information; a display unit that displays the predetermined image and displays the search conditions generated by the search condition generation unit such that the search conditions are superimposed on the displayed predetermined image; a search condition selection unit that causes a user to select the search conditions displayed on the display unit; a search condition transmission unit that transmits the search conditions selected in the search condition selection unit to the image server; and a relevant image data reception unit that receives at least one of relevant image data and information on the relevant image that are relevant to the predetermined image searched for based on the search conditions from the image server and the information tag is a bar code, a two-dimensional code, an IC tag or an electronic watermark that can be read from the captured image.

Further, it is preferable that the information terminal further comprises an imaging unit that captures the predetermined image and the information tag corresponding to the predetermined image, and acquires the captured image including the predetermined image and the information tag and the display unit displays the predetermined image based on a captured image signal of the predetermined image captured by the imaging unit.

Further, it is preferable for the relevant information selection unit and the display unit to be integrally configured as a touch panel display.

Further, it is preferable that the search conditions are the relevant information or information newly generated based on the relevant information, and the relevant information is based on information on the predetermined image input by the user, an image analysis result of the predetermined image, meta information of the predetermined image, or a combination thereof.

Further, it is preferable for the information terminal to display at least one of a relevant image based on the relevant image data and information on the relevant image received from the image server by the relevant image data reception unit on the display unit.

Further, it is preferable that the search condition generation unit generates new search conditions based on at least one of a relevant image based on the relevant image data and information on the relevant image received from the image server by the relevant image data reception unit, and the display unit displays the new search conditions generated by the search condition generation unit to be superimposed on the predetermined image.

Further, it is preferable for the information on the relevant image to be relevant information of the relevant image.

Further, the relevant information acquisition unit may acquire information on access to the relevant information from the information tag, and acquire the relevant information based on the information on access to the relevant information.

Further, the information terminal may be connected to the Internet and perform an Internet search based on the search conditions.

Further, the display unit displays the relevant image based on relevant image data regarding the predetermined image side by side as thumbnails.

Further, the present invention provides an information terminal that is connected to an image server and performs image search for a plurality of items of image data stored in the image server, the information terminal comprising: a relevant information acquisition unit that acquires relevant information of a predetermined image based on an information tag of captured image data including the predetermined image and the information tag corresponding to the predetermined image; a search condition generation unit that generates search conditions to be used for the image search in the image server based on the acquired relevant information; a display unit that displays the predetermined image and displays the search conditions generated by the search condition generation unit such that the search conditions are superimposed on the displayed predetermined image; a search condition transmission unit that transmits the search conditions generated by the search condition generation unit to the image server; and a relevant image data reception unit that receives at least one of relevant image data and information on the relevant image that are relevant to the predetermined image searched for based on the search conditions from the image server and the information tag is a bar code, a two-dimensional code, an IC tag or an electronic watermark that can be read from the captured image.

Further, the present invention provides an image search system comprising any one of the information terminals described above, and any one of the image servers described above, further comprising a printer that outputs an image print having the predetermined image stored in the storage unit of the image server and the information tag regarding the relevant information of the predetermined image.

Further, the present invention provides an image search system comprising any one of the information terminals described above, and any one of the image servers described above, further comprising a display device that displays an image having the predetermined image stored in the storage unit of the image server and the information tag regarding the relevant information of the predetermined image.

Further, the present invention provides an image search method for image-searching for a plurality of items of image data stored in an image server using an information terminal, the image search method comprising: acquiring relevant information of a predetermined image from an information tag of captured image data including the predetermined image and the information tag corresponding to the predetermined image in the information terminal; generating search conditions to be used for the image search in the image server based on the acquired relevant information; and displaying the predetermined image on a display unit of the information terminal and displaying the search conditions generated by the search condition generation unit such that the search conditions are superimposed on the displayed predetermined image and the information tag is a bar code, a two-dimensional code, an IC tag or an electronic watermark that can be read from the captured image.

Further, it is preferable for the image search method to further comprise: transmitting selected search condition from the information terminal to the image server when the search condition displayed to be superimposed on the predetermined image in the display unit of the information terminal are selected by a user; searching the plurality of items of image data stored in the image server based on the search conditions and extracting relevant image data that is relevant to the predetermined image; transmitting at least one of the relevant image data and information on a relevant image based on the relevant image data from the image server to the information terminal; and receiving, using the information terminal, the at least one of the relevant image data and the information on the relevant image transmitted from the image server and the information tag is a bar code, a two-dimensional code, an IC tag or an electronic watermark that can be read from the captured image

Further, it is preferable for the image search method to further comprise: transmitting the search conditions from the information terminal to the image server; searching the plurality of items of image data stored in the image server based on the search conditions and extracting relevant image data that is relevant to the predetermined image; transmitting at least one of the relevant image data and information on a relevant image based on the relevant image data from the image server to the information terminal; and receiving, using the information terminal, the at least one of the relevant image data and the information on the relevant image transmitted from the image server.

Further, it is preferable for the image search method to further comprise: displaying the predetermined image on the display unit of the information terminal, and displaying at least one of the relevant image based on the relevant image data and the information on the relevant image transmitted from the image server to be superimposed on the predetermined image.

Further, it is preferable for the image search method to further comprise: generating new search conditions based on at least one of the relevant image and the information on the relevant image displayed on the display unit of the information terminal and selected by the user; and searching for the plurality of items of image data stored in the image server based on the new search conditions again.

According to the present invention, it is possible to search for and refer to an image or data having high and direct relevance to the predetermined image through a simple operation without performing a keyword input or the like, and to search for and refer to a latest image or data including an image or data added after the predetermined image is captured or output. Further, since the image analysis result in the image server is used, it is possible to improve the accuracy of the search and the reference as compared to a case in which an image is read, searched for and referred to in a user terminal, and to search for and refer to an image or data for each subject in the image.

### BRIEF DESCRIPTION OF THE DRAWINGS

FIG. 1 is a block diagram illustrating an entire configuration of an image search system according to an embodiment of the present invention.

FIG. 2 is a block diagram illustrating a detailed configuration of the image search system of FIG. 1.

FIG. 3 is a flowchart in a case in which an image print having an information tag is output using the image search system of FIG. 1.

FIG. 4 is a diagram illustrating an example of an image print having a predetermined image and an information tag thereof.

FIG. 5 is a flowchart illustrating an image search method in the image search system of FIG. 1.

FIG. 6 is a diagram illustrating an example of a display in a case in which the image print illustrated in FIG. 4 is imaged by a user terminal of the present invention.

FIG. 7 is a diagram illustrating an example of a display of an image search result in the image search system of FIG. 1.

FIG. 8 is a diagram illustrating another example of a display of the image search result in the image search system of FIG. 1.

### DESCRIPTION OF THE PREFERRED EMBODIMENTS

Hereinafter, an information terminal, an image server, an image search system, and an image search method according to the present invention will be described in detail based on preferred embodiments illustrated in the accompanying drawings.

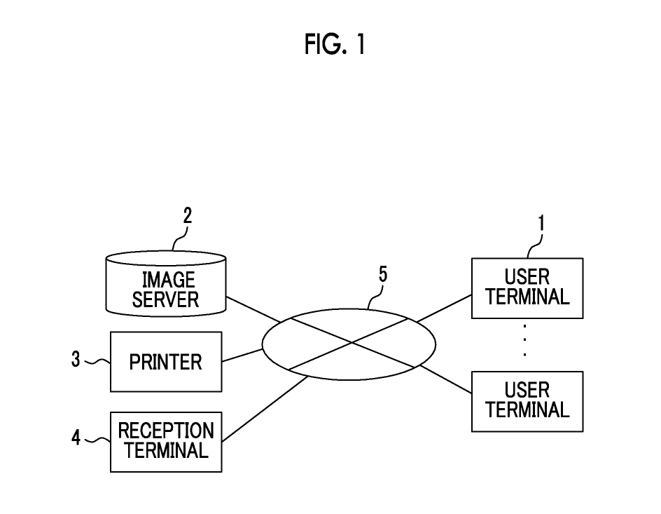

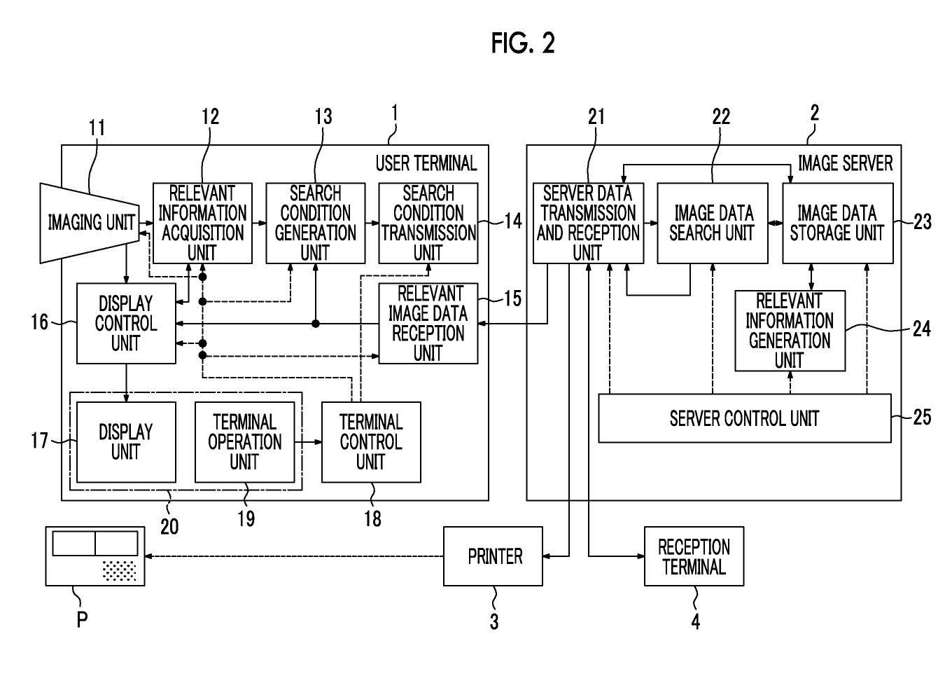

FIG. 1 is a block diagram illustrating an entire configuration of an image search system according to an embodiment of the present invention, and FIG. 2 is a block diagram illustrating a detailed configuration of the image search system of FIG. 1. The image search system according to an embodiment of the present invention includes at least one user terminal 1 that is an information terminal of the present invention, an image server 2, a printer 3, and a reception terminal 4, which are connected to each other over the Internet 5, as illustrated in FIG. 1.

The user terminal 1 is, for example, a smart phone or a tablet PC, and includes a relevant information acquisition unit 12, a search condition generation unit 13, and a search condition transmission unit 14 sequentially connected from an imaging unit 11, and a display control unit 16 and a display unit 17 similarly sequentially connected from the imaging unit 11, as illustrated in FIG. 2. Further, the display control unit 16 is connected to the search condition generation unit 13 and a relevant image data reception unit 15, the search condition generation unit 13 is connected to the relevant image data reception unit 15, a terminal control unit 18 is connected to each of the imaging unit 11, the relevant information acquisition unit 12, the search condition generation unit 13, the search condition transmission unit 14, the relevant image data reception unit 15, and the display control unit 16. A terminal operation unit 19 is connected to the terminal control unit 18.

The image server 2 is installed on, for example, the Internet, and stores a plurality of items of image data as a database. As illustrated in FIG. 2, the image server 2 includes a server data transmission and reception unit 21, an image data search unit 22, an image data storage unit 23, a relevant information generation unit 24, and a server control unit 25. The server data transmission unit 21, the image data search unit 22, and the image data storage unit 23 are connected to each other, and the relevant information generation unit 24 is connected to the image data storage unit 23. Further, the server control unit 25 is connected to each of the server data transmission and reception unit 21, the image data search unit 22, the image data storage unit 23, and the relevant information generation unit 24.

The imaging unit 11 of the user terminal 1 includes an imaging element such as a CCD image sensor or a CMOS image sensor, and acquires captured image data via an imaging optical system (not illustrated). The imaging unit 11 images a predetermined image (a predetermined print image or a predetermined display image), and an information tag corresponding to the predetermined image to acquire captured image data including the predetermined image and the information tag. Here, the information tag is, for example, a bar code, a two-dimensional code, or an electronic watermark that can be read from the captured image.

The relevant information acquisition unit 12 analyzes, for example, the captured image based on the captured image data, and acquires relevant information of the predetermined image from the information tag on the captured image. Here, although details will be described below, the relevant information is information that is relevant to the predetermined image.

The search condition generation unit 13 generates search conditions based on the relevant information, and outputs the search conditions to the search condition transmission unit 14. Here, the search conditions are information that is generated based on the relevant information and used when the image is searched for, and may be relevant information itself, may be information that is newly generated using the relevant information and search date and time information, may be information that is newly generated by combining a plurality of relevant information, or may be information that is newly generated using the relevant information and user information accumulated by the user terminal 1.

The search condition transmission unit 14 transmits the search conditions to the image server 2 over the above-described Internet 5 or the like.

The relevant image data reception unit 15 receives at least one of the relevant image data and the information on the relevant image from the image server 2 over the above-described Internet 5. Although details thereof will be described below, the relevant image data is image data of an image relevant to the predetermined image searched for based on the search conditions and extracted in the image server 2, and the information on the relevant image includes relevant information of the relevant image or includes information on access to the relevant image data together with the relevant information of the relevant image.

The display control unit 16 acquires the captured image data from the imaging unit 11 and the search conditions from the search condition generation unit 13, and controls the display unit 17 so that the search conditions are displayed on the captured image.

The display unit 17 is, for example, a liquid crystal display, and displays the captured image based on the captured image data and displays the search conditions to be superimposed on the captured image.

The terminal control unit 18 controls each of the imaging unit 11, the relevant information acquisition unit 12, the search condition generation unit 13, the search condition transmission unit 14, the relevant image data reception unit 15, and the display control unit 16 based on, for example, an instruction of the user through the terminal operation unit 19 or a predetermined program.

The terminal operation unit 19 used for the user to input the instruction or the like includes, for example, an operation button with which the user performs an operation input. The display unit 17 and the terminal operation unit 19 of the user terminal 1 described above may be integrally configured with one touch panel 20. For example, in the smart phone or the tablet PC described above, the display unit and the terminal operation unit are generally configured as one touch panel. Further, the terminal operation unit 19 corresponds to the relevant information selection unit of the present invention.

The server data transmission and reception unit 21 of the image server 2 receives the search conditions from the user terminal 1 over the Internet 5, and transmits at least one of the relevant image data and the information on the relevant image to the user terminal 1. The server data transmission and reception unit 21 is connected to the printer 3 and the reception terminal 4 over the Internet 5, transmits the print data of the print image such as a photobook or a postcard including a predetermined image and an information tag having relevant information thereof described in to the printer 3, and receives the image data uploaded by the user or a print instruction for the image print by the user from the reception terminal 4.

The image data search unit 22 searches for a plurality of items of image data stored in the image data storage unit 23 based on the search condition, and extracts the relevant image data relevant to the predetermined image and the information on the relevant image.

The image data storage unit 23 stores, for example, a plurality of items of image data. For example, the image data storage unit 23 stores the image data uploaded by the user via the reception terminal 4 or the relevant information generated by the relevant information generation unit 24 together with corresponding image data. The relevant information is stored in association with the corresponding image data.

The relevant information generation unit 24 generates the relevant information of the image data stored in the image data storage unit 23. Here, the relevant information of the image data is information that is used to generate the search conditions in the search condition generation unit 13, is relevant to predetermined image data, and becomes a basis for searching for and extracting other image data stored in the image data storage unit 23 using the image data search unit 22, and includes, for example, a keyword that is relevant to the predetermined image and is common to a plurality of images. The relevant information of the image data described above is generated based on, for example, information on an image group classified and input by the user, an image analysis result, and meta information of the image. Information on an image group classified when the user uploads an image or a classification name of an image group directly written by the user, or a common term of the image group (for example, information on a subject such as birthday of each subject or a hobby of each subject) directly written by the user, for example, is considered as the information on an image group classified and input by the user. A composition of an image obtained through image analysis, image extraction processing information such as a size of a person or a face, automatic image quality correction processing information such as exposure of the image or a scene identification result (for example, person, blue sky, or sunset), and face recognition (person recognition) information based on, for example, face information registered in a database, for example, are considered as the image analysis result. Imaging date and time, an imaging place (GPS information), and imaging conditions, or information on an image (for example, image name, classification of the image, keywords regarding the image, information on a subject reflected in the image, or information on an imaging situation of the image) input by the user is considered as the meta information of the image.

The server control unit 25 controls each of the server data transmission and reception unit 21, the image data search unit 22, the image data storage unit 23, and the relevant information generation unit 24 based on, for example, the instruction of the user from the user terminal 1, the reception terminal 4, or the like or a predetermined program.

The printer 3 is, for example, a network printer available over the Internet 5, and outputs a print image on which the predetermined image and an information tag having the relevant information of the predetermined image described therein are printed. Examples of the print image may include a photobook, a collage, a normal digital camera print, and a postcard.

Further, the reception terminal 4 is installed in, for example, a store, and outputs registered image data to the image server 2 over the Internet 5 in a case in which the image data is registered from a recording medium such as a memory card brought by the user. Further, the reception terminal 4 is in conjunction with the image server 2 and the printer 3 to search for and view the image data stored in the image server 2 based on the instruction of the user, and outputs the image print from the printer 3 based on the instruction of the user.

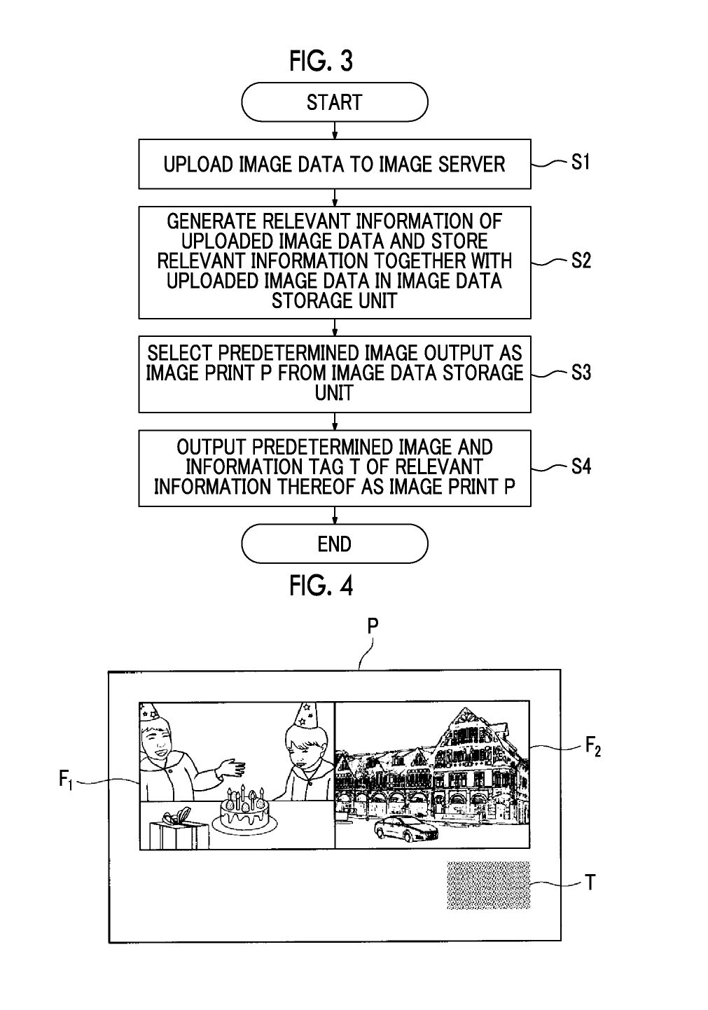

Next, an operation of outputting the image print using the image search system of FIG. 1 will be described based on a flowchart of FIG. 3.

If the user uploads the image data to the image server 2 via the reception terminal 4 or the like as shown in step Si of FIG. 3, the relevant information generation unit 24 of the image server 2 generates relevant information of the uploaded image data and stores the relevant information together with the uploaded image data in the image data storage unit 23 based on an instruction from the server control unit 25, as shown in step S2.

Then, in step S3, the user selects at least one image stored in the image data storage unit 23 of the image server 2 as a predetermined image using the reception terminal 4 or the like, and instructs the printer 3 to output an image print.

If the output is instructed, an image print P on which the predetermined image and an information tag T including the relevant information thereof are printed is output from the printer 3 in step S4.

FIG. 4 is a schematic diagram illustrating an example of the image print P. The image print P is an image print on which predetermined images F1 and F2 selected by the user, and the information tag T including relevant information of the predetermined images F1 and F2 are printed. The information tag T includes not only the relevant information of the predetermined images F1 and F2, but also information necessary to display search conditions generated based on the relevant information, such as position information of the predetermined images F1 and F2 in the image print P or image content of the predetermined images F1 and F2, and a subject and a positional relationship thereof in the predetermined images F1 and F2, to be superimposed on the predetermined images F1 and F2.

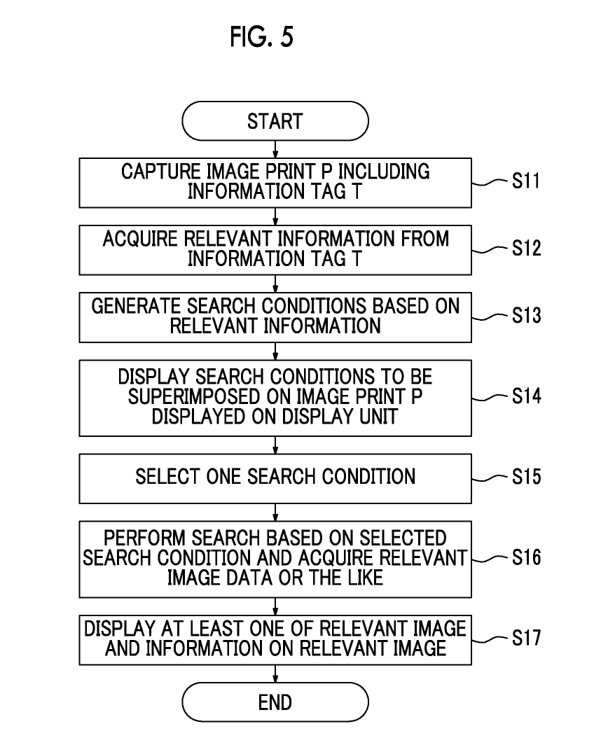

Next, an operation (image search method) of the image search system in FIG. 1 based on the image print P in FIG. 4 will be described based on a flowchart of FIG. 5.

In step S11, if the user operates the user terminal 1 and captures the image print P including the predetermined images F1 and F2 and the information tag T using the imaging unit 11, the imaging unit 11 of the user terminal 1 outputs captured image data of the captured image including the predetermined images F1 and F2 and the information tag T to the relevant information acquisition unit 12 and the display control unit 16 based on an instruction from the terminal control unit 18.

Then, in step S12, the relevant information acquisition unit 12 acquires the relevant information from the information tag T of the captured image based on the captured image data and outputs the relevant information to the search condition generation unit 13, based on an instruction from the terminal control unit 18.

In step S13, the search condition generation unit 13 generates the search condition based on the relevant information acquired from the relevant information acquisition unit 12, and outputs the generated search condition to the search condition transmission unit 14 and the display control unit 16. The search condition generation unit 13, for example, can search for a birthday image group of this year from a birthday print of last year or search for an image group of events of this year in which a participant of a trip is reflected as a subject from a trip print of last year since the search condition generation unit 13 generates the search condition at the time of imaging of the image print P.

In step S14, the display control unit 16 displays the captured image on the display unit 17 based on the captured image data output from the imaging unit 11 and displays the search condition output from the search condition generation unit 13 to be superimposed on the captured image. Since the captured image is an image of the image print P, the search conditions are displayed to be superimposed on the image print P.

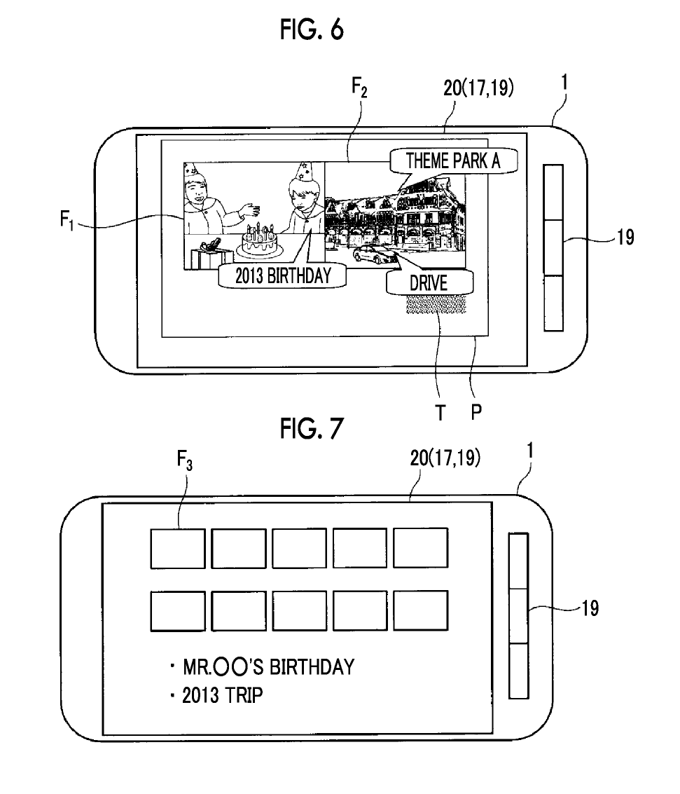

FIG. 6 is an illustrative diagram illustrating an example of a display of the display unit 17 of the user terminal 1 in a case in which the image print P in FIG. 4 is captured by the user terminal 1. For example, a search condition regarding a child's birthday (“2013 birthday”) is displayed on the predetermined image F1 of the image print P. The search condition regarding the child's birthday is generated by the search condition generation unit 13 of the user terminal 1 based on relevant information obtained based on face recognition (person recognition) in the relevant information generation unit 24 of the image server 2.

Further, for example, a search condition (“Theme park A”) regarding a building reflected in the predetermined image F2 and a search condition (“Drive”) regarding a car reflected in the predetermined image F2 are displayed on the predetermined image F2. The search condition regarding the building is generated by the search condition generation unit 13 from, for example, meta-information such as imaging date and time and an imaging position obtained in the relevant information generation unit 24, or the relevant information such as a classification of an image group input by the user, and the search condition regarding the car is generated by the search condition generation unit 13 from the image analysis result obtained by the relevant information generation unit 24.

In step S15, if the user operates the terminal operation unit 19 of the user terminal 1 and selects the search condition reflected on the image print P, the terminal control unit 18 instructs the search condition transmission unit 14 to transmit the search conditions selected by the user to the image server 2. The search condition transmission unit 14 outputs the search conditions selected by the user to the server data transmission and reception unit 21 of the image server 2.

The server data transmission and reception unit 21 of the image server 2 receives the search conditions selected by the user and outputs the search conditions to the image data search unit 22. In step S16, the image data search unit 22 searches for the image data stored in the image data storage unit 23 based on the search conditions selected by the user to extract the relevant image data, and outputs at least one of the extracted relevant image data and information on the relevant image to the relevant image data reception unit 15 of the user terminal 1 via the server data transmission and reception unit 21 based on an instruction from the server control unit 25. Here, the relevant image data is image data itself of the relevant image, and the information on the relevant image is relevant information of the relevant image generated and stored to correspond to the relevant image in advance.

The relevant image data reception unit 15 outputs at least one of the acquired relevant image data and the acquired information on the relevant image to the display control unit 16 based on an instruction from the terminal control unit 18. In step S17, the display control unit 16 displays at least one of the relevant image based on the relevant image data and the information on the relevant image on the display unit 17. For the display of the relevant image and the information on the relevant image on the display unit 17, for example, the relevant images may be displayed side by side as thumbnails (for example, thumbnail “F3”) as illustrated in FIG. 7 or the information on the relevant image may be displayed using a bullet point.

Further, the user terminal 1 may output the relevant image data and the information on the relevant image acquired by the relevant image data reception unit 15 to the search condition generation unit 13 based on the instruction of the terminal control unit 18. The search condition generation unit 13 may generate new search conditions based on the relevant image data and the information on the relevant image, and display the new search conditions together with the above-described search conditions to be superimposed on the image print P displayed on the display unit 17. The search condition generation unit 13 may display the new search conditions using a bolder frame than that for the original search conditions so that the original search conditions and the new search conditions can be distinguished from each other (“2013 trip”), and may propose creating a product such as a photobook composed of the predetermined image and the relevant image thereof (“* Create New Photobook!”). The above-described distinguishment is not limited to the bold frame display, and any method may be used as long as the method allows recognizing a difference in original search conditions, new search conditions, and proposals of creation of a product displayed to be superimposed on the image print. Various known display methods such as changing a type and a size of font, using a bold type, or changing colors may be used. Further, as the search condition, the thumbnail “F3” of the relevant image may be displayed to be superimposed on the image print P. Further, only the new search conditions displayed on the display unit 17 may also be displayed to be superimposed on the image print P.

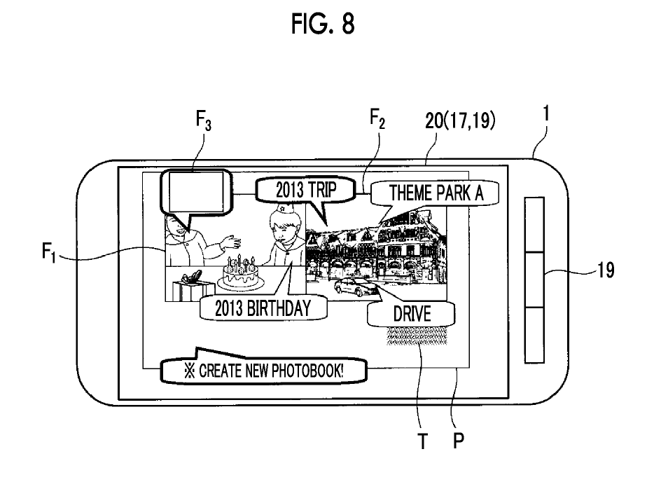

Further, in the case of any one of the display in FIG. 7 and the display in FIG. 8, the image data stored in the image server 2 may be searched for from new search conditions based on the relevant image and the information on the relevant image again, and at least one of the relevant image data and the information on the relevant image may be acquired again, similar to the above.

As described above, in the image search system according to an embodiment of the present invention, it is possible to search for and refer to an image or data having high and direct relevance to the predetermined image through a simple operation without performing a keyword input or the like, and to search for and refer to a latest image or data including an image or data added after the predetermined image is captured or output.

Further, since the image analysis result in the image server is used, it is possible to improve accuracy of the search and the reference as compared to a case in which an image is read, searched for and referred to in the user terminal, and to search for and refer to an image or data for each subject in the image.

Further, while the image data search (image search) is performed in the image server 2 only for the search conditions selected by the user, and at least one of the relevant image data and the information on the relevant image is acquired in the above-described operation of the image search system illustrated in FIG. 5, the search condition generation unit 13 of the user terminal 1 may output all of search conditions generated based on the relevant information acquired from the information tag T to the image server 2, the image data search may be performed based on all the search conditions, and at least one of the relevant image data and the information on the relevant image may be acquired.

In this case, it is not necessary for the user to select the search conditions displayed on the display unit 17, the image data search may be performed in the image server 2 based on all of the search conditions, and in the display unit 17, the at least one of the relevant image and the information on the relevant image may be displayed on the display unit 17 when the user terminal 1 receives the at least one of the relevant image data and the information on the relevant image. In this case, the at least one of the relevant image and the information on the relevant image may be displayed together with the search conditions to be superimposed on the predetermined image, similar to the above-described case. Further, the search condition generation unit may generate new search conditions based on the at least one of the relevant image data and the information on the relevant image, search for the image data stored in the image server 2 based on the new search conditions again, and acquire the at least one of the relevant image data and the information on the relevant image again.

Further, although the image search system of FIG. 1 performs the image data search based on the search condition, the user terminal 1 may be connected to a search server on the Internet, perform an Internet search based on a search condition, and display a search result. Further, by operating the terminal operation unit 19, the image data search and Internet search may be selected.

Although, in the user terminal 1 of the above-described image search system, the relevant information acquisition unit 12 acquires the relevant information from the information tag of the captured image based on the captured image data acquired by the imaging unit 11, for example, in a case in which the information tag is an IC tag, the relevant information acquisition unit 12 of the user terminal 1 may include a dedicated reading device, and the relevant information of the predetermined image may be acquired without via the captured image by the dedicated reading device.

Further, the relevant information acquisition unit 12 of the user terminal 1 acquires the relevant information of the predetermined image from the information tag on the captured image, but the present invention is not limited thereto. For example, information on access to the relevant information of the predetermined image may be acquired from the information tag on the captured image and, for example, the relevant information acquisition unit 12 of the user terminal 1 may be connected to the image server 2 based on the acquired access information and acquire the relevant information of the predetermined image stored in the image data storage unit 23 of the image server 2. A connection destination of the user terminal 1, that is, a storage destination of the relevant information of the predetermined image is not limited to the image server 2, and may be, for example, an external server in which the relevant information of the predetermined image is stored.

The relevant information of the image is generated by the relevant information generation unit 24, for example, when the image data is stored in the image server 2, but the present invention is not limited thereto. The relevant information may be generated by a device other than the image server before the image data is stored in the image server. For example, an information terminal may include a relevant information generation unit, and when an image is captured by an imaging unit of the information terminal, the relevant information may be generated based on image data output from the imaging unit. In this case, the relevant information is transmitted together with the captured image data to the image server and stored in association with the captured image data.

Further, although the relevant information generation unit 24 of the image server 2 generates the relevant information of the image when the image is uploaded to the image server 2, a score of the image may be added as the relevant information, for example, based on a predetermined criterion. By using the score as the relevant information, search and extraction of the image data using the score can be performed. For example, an image with a predetermined score or more or an image within a range of predetermined score is extracted.

Further, in the above-described image search system, the user terminal 1 acquires the relevant information of the predetermined image by imaging the image print P including the information tag T output from the printer 3, but the present invention is not limited thereto. For example, the image search system may include a display device in place of the printer and may acquire the relevant information of the predetermined image by capturing the image of the image print including the information tag displayed on the display device using the user terminal.

Further, the user terminal may acquire display image data of the image print including the information tag through communication or the like and acquire the relevant information of the predetermined image from the display image data of the image print. In this case, imaging of the image print or the like using the user terminal is not necessary.

The information terminal, the image server, the image search system, and the image search method of the present invention have been described above in detail, but the present invention is not limited to the above embodiments, and various improvements and modifications can be performed without departing from the gist of the present invention.

### EXPLANATION OF REFERENCES

1: user terminal

2: image server

3: printer

4: reception terminal

5: Internet

11: imaging unit

12: relevant information acquisition unit

13: search condition generation unit

14: search condition information transmission unit

15: relevant image data reception unit

16: display control unit

17: display unit

18: terminal control unit

19: terminal operation unit

20: touch panel

21: server data transmission and reception unit

22: image data search unit

23: image data storage unit

24: relevant information generation unit

25: server control unit

F1, F2: predetermined image

F3: thumbnail

P: image print

T: information tag.

What is claimed is:

1. An information terminal that is connected to an image server and performs an image search for a plurality of items of image data stored in the image server, the information terminal comprising:
a relevant information acquisition unit that acquires relevant information of a predetermined image based on an information tag of captured image data including the predetermined image and the information tag corresponding to the predetermined image;
a search condition generation unit that generates search conditions to be used for the image search in the image server based on the acquired relevant information;
a display unit that displays the predetermined image and displays the search conditions generated by the search condition generation unit such that the search conditions are superimposed on the displayed predetermined image;
a search condition selection unit that causes a user to select the search conditions displayed on the display unit;
a search condition transmission unit that transmits the search conditions selected in the search condition selection unit to the image server; and
a relevant image data reception unit that receives at least one of relevant image data and information on the relevant image that are relevant to the predetermined image searched for based on the search conditions from the image server,
wherein the information tag is a bar code, a two-dimensional code, an IC tag or an electronic watermark that can be read from the captured image.

2. The information terminal according to claim 1, further comprising:
an imaging unit that captures the predetermined image and the information tag corresponding to the predetermined image, and acquires the captured image including the predetermined image and the information tag,
wherein the display unit displays the predetermined image based on a captured image signal of the predetermined image captured by the imaging unit.

3. The information terminal according to claim 1,
wherein the relevant information selection unit and the display unit are integrally configured as a touch panel display.

4. The information terminal according to claim 1,
wherein the search conditions are the relevant information or information newly generated based on the relevant information, and
the relevant information is based on information on the predetermined image input by the user, an image analysis result of the predetermined image, meta information of the predetermined image, or a combination thereof.

5. The information terminal according to claim 1,
wherein the information terminal displays at least one of a relevant image based on the relevant image data and information on the relevant image received from the image server by the relevant image data reception unit on the display unit.

6. The information terminal according to claim 1,
wherein the search condition generation unit generates new search conditions based on at least one of a relevant image based on the relevant image data and information on the relevant image received from the image server by the relevant image data reception unit, and
the display unit displays the new search conditions generated by the search condition generation unit to be superimposed on the predetermined image.

7. The information terminal according to claim 1,
wherein the information on the relevant image is information on access to the relevant image data or relevant information of the relevant image.

8. The information terminal according to claim 1,
wherein the relevant information acquisition unit acquires information on access to the relevant information from the information tag, and acquires the relevant information based on the information on access to the relevant information.

9. The information terminal according to claim 1,
wherein the information terminal is connected to the Internet and performs an Internet search based on the search condition.

10. An information terminal that is connected to an image server and performs an image search for a plurality of items of image data stored in the image server, the information terminal comprising:
a relevant information acquisition unit that acquires relevant information of a predetermined image based on an information tag of captured image data including the predetermined image and the information tag corresponding to the predetermined image;
a search condition generation unit that generates search conditions to be used for the image search in the image server based on the acquired relevant information;
a display unit that displays the predetermined image and displays the search conditions generated by the search condition generation unit such that the search conditions are superimposed on the displayed predetermined image;
a search condition transmission unit that transmits the search conditions generated by the search condition generation unit to the image server; and
a relevant image data reception unit that receives at least one of relevant image data and information on the relevant image that are relevant to the predetermined image searched for based on the search conditions from the image server,
wherein the information tag is a bar code, a two-dimensional code, an IC tag or an electronic watermark that can be read from the captured image.

11. An image search system comprising the information terminal according to claim 1, and an image server, further comprising:
a printer that outputs an image print having the predetermined image stored in a storage unit of the image server and the information tag regarding the relevant information of the predetermined image.

12. An image search system comprising the information terminal according to claim 1, and an image server, further comprising:
a display device that displays an image having the predetermined image stored in a storage unit of the image server and the information tag regarding the relevant information of the predetermined image.

13. An image search method for image-searching for a plurality of items of image data stored in an image server using an information terminal, the image search method comprising:
acquiring relevant information of a predetermined image from an information tag of captured image data including the predetermined image and the information tag corresponding to the predetermined image in the information terminal;
generating search conditions to be used for the image search in the image server based on the acquired relevant information; and
displaying the predetermined image on a display unit of the information terminal, and displaying the search conditions generated by the search condition generation unit such that the search conditions are superimposed on the displayed predetermined image,
wherein the information tag is a bar code, a two-dimensional code, an IC tag or an electronic watermark that can be read from the captured image.

14. The image search method according to claim 13, further comprising:
transmitting a selected search condition from the information terminal to the image server when the search condition displayed to be superimposed on the predetermined image in the display unit of the information terminal are selected by a user;
searching the plurality of items of image data stored in the image server based on the search conditions and extracting relevant image data that is relevant to the predetermined image;
transmitting at least one of the relevant image data and information on a relevant image based on the relevant image data from the image server to the information terminal; and
receiving, by the information terminal, the at least one of the relevant image data and the information on the relevant image transmitted from the image server.

15. The image search method according to claim 13, further comprising:
transmitting the search conditions from the information terminal to the image server;
searching the plurality of items of image data stored in the image server based on the search conditions and extracting relevant image data that is relevant to the predetermined image;
transmitting at least one of the relevant image data and information on a relevant image based on the relevant image data from the image server to the information terminal; and
receiving, by the information terminal, the at least one of the relevant image data and the information on the relevant image transmitted from the image server.

16. The image search method according to claim 14, further comprising:
displaying the predetermined image on the display unit of the information terminal, and displaying at least one of the relevant image based on the relevant image data and the information on the relevant image transmitted from the image server to be superimposed on the predetermined image.

17. The image search method according to claim 14, further comprising:
generating new search conditions based on at least one of the relevant image and the information on the relevant image displayed on the display unit of the information terminal and selected by the user; and
searching for the plurality of items of image data stored in the image server based on the new search conditions again.

18. An image search system comprising the information terminal according to claim 1,
wherein the display unit displays the relevant image based on relevant image data regarding the predetermined image side by side as thumbnails.
